(19) United States
(12) Patent Application Publication
(10) Pub. No.: US 2022/0206919 A1
(43) Pub. Date: Jun. 30, 2022

(54) SELF-ADAPTIVE CIRCUIT BREAKERS FOR APPLICATIONS THAT INCLUDE EXECUTION LOCATION MARKERS

(71) Applicant: Hewlett-Packard Development Company, L.P., Spring, TX (US)

(72) Inventors: Mauricio Coutinho Moraes, Porto Alegre (BR); Daniele Antunes Pinheiro, Porto Alegre (BR); Jhonny Marcos Acordi Mertz, Porto Alegre (BR)

(73) Assignee: Hewlett-Packard Development Company, L.P., Spring, TX (US)

(21) Appl. No.: 17/608,327

(22) PCT Filed: Sep. 12, 2019
(86) PCT No.: PCT/US2019/050723

§ 371 Date: Nov. 2, 2021

(51) Int. Cl. G06F 11/30

(52) U.S. Cl. CPC G06F 11/3055; G06F 11/3072

(57) ABSTRACT

An example system includes: an application engine comprising code segments and execution location markers which return time indicators identifying times to implemented the code segments; a circuit breaker (CB) awareness builder engine to: receive from the application engine, the time indicators; and store the time indicators; a CB awareness engine to: receive a request to process the application engine; retrieve, via the CB awareness builder engine, the time indicators; determine whether a code segment is open or closed based on the time indicators; modify the request to include CB indications of respective code segments of the application engine that are open; and provide the request, as modified to include the CB indications, to the application engine to cause the application engine to return an exception for open code segments in response to receiving the request, as modified to include the CB indications.

### BACKGROUND

Identification of behavior of an application, for example an application that corresponds to a website, may occur by running the application offline, for example by testing the application under certain conditions.

### BRIEF DESCRIPTION OF THE DRAWINGS

Reference will now be made, by way of example only, to the accompanying drawings in which:

FIG. 1 is a block diagram of an example system to implement self-adaptive circuit breakers for applications that include execution location markers.

FIG. 2 a block diagram of another example system to implement self-adaptive circuit breakers for applications that include execution location markers.

FIG. 3 is a flow diagram of an example method to implement self-adaptive circuit breakers for applications that include execution location markers.

FIG. 4 is a block diagram of an example computer-readable medium including instructions that causes a processor to implement self-adaptive circuit breakers for applications that include execution location markers.

FIG. 5 is an example of a code snippet which includes execution location markers.

FIG. 6 is an example of the system of FIG. 2 storing time stamps in association with location indicators of execution location markers that generated the time stamps.

FIG. 7 is an example of the system of FIG. 2 using the time stamps and associated location indicators to open a circuit and/or a connection and/or code segment at an application engine.

### DETAILED DESCRIPTION

Identification of behavior of an application, for example an application that corresponds to a website, may occur by running the application offline, for example by testing the application under certain conditions. However, such an approach may be inefficient and may not represent behavior of the application in real-time time. Furthermore, resilience is a concept in the prevention of unrestrained widespread failures in a distributed system, of which a website may be one example. If one component of a distributed system fails, but that failure doesn't cascade, the problem may be isolated and the whole distributed system may degrade functionality accordingly.

However, as described herein, an application may be made “self-aware” and/or “self-adaptive” by providing the application with execution location markers which return time indicators identifying times to execute code segments of the application. The time indicators may comprise time stamps of when an execution location marker was executed, for example, and may be stored. In response to receiving a request to process the application, the stored time indicators may be used to determine whether a code segment (which generally forms at least part of a circuit and/or a connection in the application) is opened or closed. Circuit breaker indications of respective code segments of the application engine that are open may be added to the request (e.g., in a header of the request) to cause the application to return an exception (e.g., an error) for open code segments. An execution location marker associated with the open code segment may return the exception which may generally prevent the open code segment from being executed and/or prevent code segments, that follow the open code segment in the circuit, from being executed.

Hence, provided herein is a system comprising: an application engine comprising code segments and execution location markers which return time indicators identifying times to execute the code segments; a circuit breaker (CB) awareness builder engine to: receive from the application engine, the time indicators; and store the time indicators; a CB awareness engine to: receive a request to process the application engine; retrieve, via the CB awareness builder engine, the time indicators; determine whether a code segment is open or closed based on the time indicators; modify the request to include CB indications of respective code segments of the application engine that are open; and provide the request; as modified to include the CB indications; to the application engine to cause the application engine to return an exception for open code segments in response to receiving the request, as modified to include the CB indications.

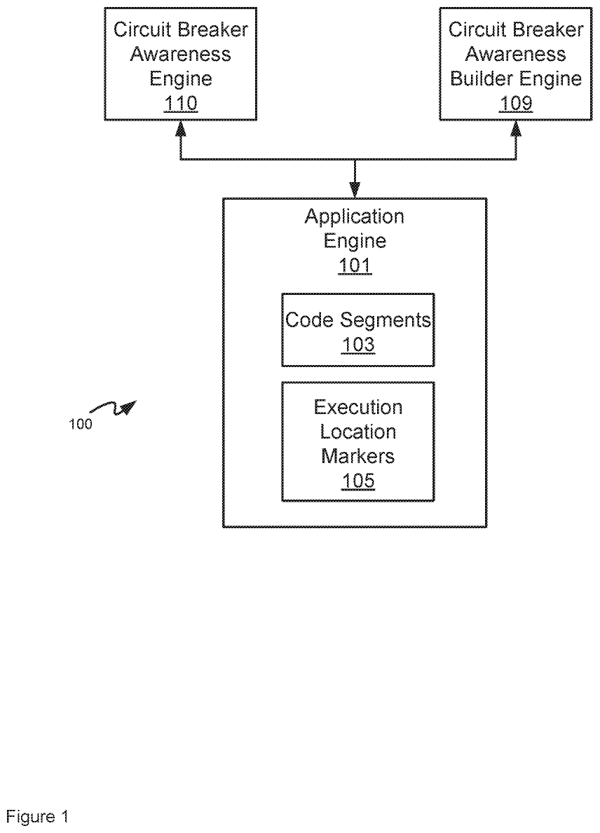

FIG. 1 is a block diagram of an example system 100 to implement self-adaptive circuit breakers for applications that include execution location markers. The system 100 may include an application engine 101 comprising code segments 103 and execution location markers 105, a circuit breaker (013) awareness builder engine 109 and a 013 awareness engine 110.

As will be described in more detail below, the code segments 103 may comprise portions and/or segments of code and/or source code and/or executable instructions, and the like, of an application executed when the application engine 101 is implemented, and the like.

As will be described in more detail below, the execution location markers 105 may generally comprise functions and/or engines and/or executable instructions, and the like, which return indicators identifying behavior of the code segments 103; while the execution location markers 105 will be described in more detail below, in some examples the indicators returned by the execution location markers 105 may comprise: a line number of an application executed when the application engine 101 is implemented, and the like, at which an execution location marker 105 is located; and/or exceptions (e.g. errors).

As used herein, the term “engine” refers to hardware (e.g., a processor, such as a central processing unit (CPU) an integrated circuit or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or implemented or interpreted by a processor), or hardware and software hosted at hardware.

For example, the application engine 101 may comprise hardware or a combination of software and hardware for implementing an application, such as a website, and the like. In some examples, the application engine 101 may comprise a portion of a server which hosts the application and/or the website. However, the application engine 101 may comprise hardware or a combination of software and hardware which correspond to any suitable application.

The application engine 101 comprises the code segments 103 and the execution location markers 105. The execution location markers 105 return time indicators identifying times to execute the code segments 103 in response to receiving a request to process the application engine 101. is understood that processing the application engine 101 may include controlling the hardware and/or software of the application engine 101 to implement and/or process an application and/or executable instructions of the application engine 101.

For example, a request may be received via a communications network and the like, for example from a requesting device and/or a client device, and the like. The request may be to implement and/or process the application engine 101 (and/or an application thereof). The request may comprise a HyperText Transfer Protocol (HTTP) request transmitted to a server implementing the application engine 101, for example to implement a website.

The application engine 101 receives the request and may responsively implement the code segments 103 and the execution location markers 105. The execution location markers 105 may return time indicators identifying times to execute the code segments during the execution, for example at a run-time of the application engine 101 and/or in real-time. In particular, the time indicators may comprise time stamps of when an execution location marker 105 was implemented.

While not depicted, such a request may be received via an application manager engine which may comprise an application programming interface (API) of the application engine 101. Put another way, an application manager engine and/or an API may generally receive the request and pass the request to the application engine 101.

Furthermore, as will be described in more detail below, such a request may also be received via the CB awareness engine 110, which may add CB indications to the request (e.g., in a header and/or an HTTP header).

The application engine 101 may generate a response to the request that includes the time indicators identifying times to execute the code segments 103, as generated by the execution location markers 105.

The CB awareness builder engine 109 generally: receives from the application engine 101, the time indicators; and store the time indicators.

In some examples, the time indicators may be included in a header of the response as received from the application engine 101. For example, the request may comprise an HTTP request, and the response may comprise an HTTP response, with the time indicators in an HTTP header thereof. However, the time indicators may be included in the response in any suitable manner.

The CB awareness builder engine 109 stores the time indicators, for example, local to the CB awareness builder engine 109, and transmits the response, for example back to the requesting device.

The time indicators may be stored at a database, and the like, maintained by the application manager engine, and/or in any other suitable memory and/or memory structure accessible to the CB awareness builder engine 109, for example local to an API, and the like, of the application engine 101.

In some examples, the CB awareness builder engine 109 may remove the time indicators from the response prior to transmitting the response. In other examples, the CB awareness builder engine 109 may not remove the time indicators, and the response may be transmitted with the time indicators; in these examples, the requesting device may receive the time indicators, and may optionally process the time indicators.

The time indicators may generally comprise a time stamp of an execution location marker 105, such as a relative or absolute time that an execution location marker 105 was implemented. In some of these examples, execution location markers 105 may precede and follow a code segment 103 and/or code segments 103 and hence the time indicators may comprise a pair of time stamps which indicate a time for executing a code segment 103, and/or code segments 103, between two associated execution location markers 105. Put another way, the time indicators may indicate execution delay times for respective code segments 103.

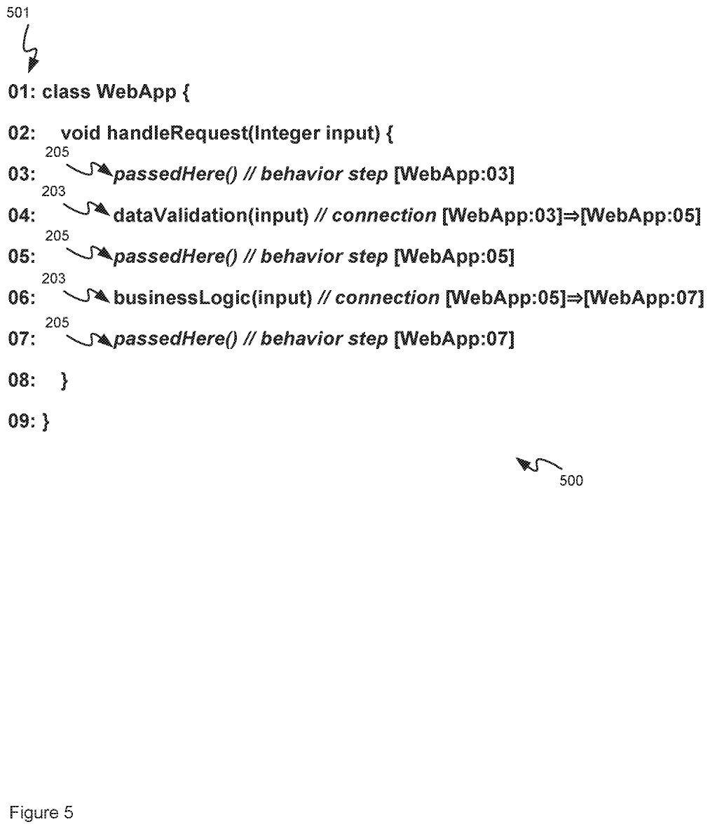

Code segments 103 between a pair of execution location markers 105 may be referred to a “connection” of the application engine 101; a “circuit” may comprise a connection and/or a plurality of connections. For example, the application engine 101 may comprise a first execution location marker 105 and a last execution location marker 105 with execution locations markers 105 therebetween. Such a structure may be referred to as a circuit, with pairs of closest execution location marker 105 comprising connections in the circuit. Connections may include a code segment 103 and/or code segments 103. Hence, code segments 103 may form connections, and connections may form circuits, with pairs of execution location markers indicating a beginning and end of a connection, and first and last execution location markers of a group of connections indicating a beginning and end of a circuit formed by the connections. Examples of code segments, connections and circuits, as well as execution location markers, are described below with respect to FIG. 5. Hereafter, reference to a code segment being open, half-open, or closed, and the like, is understood to also refer to a circuit and/or connection being open, half-open, or closed, and the like.

In some examples, the time indicators may include location indications of respective execution location markers 105 associated with respective code segments 103. Alternatively, the location indications may be received with the location indications. For example, such location indications may indicate a line number of an execution location marker 105 that returned a respective time stamp. Hence, by comparing the time stamps, a time to execute code segments 103 (e.g., a circuit and/or a connection) between the line numbers, indicated by the location indications, may be determined. However, locations associated with time stamps and/or time indicators may be received in any suitable manner, and/or the CB awareness builder engine 109 may determine locations associated with time stamps and/or time indicators in any suitable manner.

In general, the stored time indicators may be used to determine whether a code segment 103 and/or code segments 103 and/or a circuit and/or a connection is open or closed.

For example, the CB awareness engine 110 is to: receive a request to process the application engine 101; retrieve, via the CB awareness builder engine 109, the time indicators; determine whether a code segment 103 (and/or code segments 103 and/or a circuit and/or a connection) is open or closed based on the time indicators; modify the request to include CB indications of respective code segments of the application engine 101 that are open; and provide the request, as modified to include the CB indications, to the application engine 101 to cause the application engine 101 to return an exception for open code segments in response to receiving the request, as modified to include the CB indications. For example, a CB indication may comprise a line number of an execution location marker 105 prior, and adjacent to, a code segment 103 that is open. The code segment 103 may be part of a connection which may be part of a circuit. The application engine 101 receives the line number, and the execution location marker 105 at the line number returns an exception, such as an error, and the like, which causes the code segments 103 following the execution location marker 105 to not execute. As such, the circuit and/or connection of which the open code segment 103 is a component may also be referred to as being open; as the circuit and/or connection does not complete, the circuit and/or connection may be referred to as being “broken”, at least temporarily, and hence the structure and/or functionality of the engines 109, 110, as described, may be referred to as a circuit breaker. Hence the terms “CB awareness builder engine” and “CB awareness engine” refer to circuit breaking in the application engine 101 which may include, but is not limited to, connection breaking of one connection in a circuit.

For example, the CB awareness engine 110 may receive the request, and communicate with the CB awareness builder engine 109 to determine previous execution times of the code segments 103 based on the stored time indications (e.g., and the location indications). The CB awareness engine 110 may be further to: compare the times of the time indicators (e.g., the time stamps) to a threshold to determine whether a code segment 103 is open or closed. Such a threshold may comprise any suitable threshold time and/or threshold criteria, and may be relative (and/or dynamic) and/or absolute. For example, the threshold may be determined from previously stored time indicators, and/or a threshold time may be based on statistics, such as average time for a code segment 103, and the like, to execute (and which may be adjusted based on a standard deviation from the average time). Put another way, the respective thresholds and/or threshold times may be based on statistics for execution times for respective code segments 103, defined by pairs of execution location markers 105 associated with a respective code segment 103.

In some examples, a threshold for a code segment 103, and the like, may be a relative and/or dynamic threshold time, such as an average execution time plus one standard deviation of the code segment 103, and the like, for a last given time period (e.g., the last 3 hours). In other examples, a threshold for a code segment 103, and the like, may be an absolute threshold time, such as 250 milliseconds. In yet further examples, a threshold time for a code segment 103, and the like, may be a hybrid of a relative threshold time and an absolute threshold time, and/or conditional; for example, an absolute threshold time may be used until enough “historical” time indicators (e.g., 1000, or any suitable number) have been received to provide a statistically significant average execution time and standard deviations thereof, and then a relative threshold time may be used.

In yet further examples, a threshold for a code segment 103 and/or a circuit and/or a connection may not be only time based, but may be based on any other suitable threshold criteria, which may be relative (and/or dynamic) or absolute. For example, a relative and/or dynamic threshold criteria may be “in response to 10% of executions of a code segment 103, that occurred in the last 5 minutes, being unacceptably” “slow” (as determined using a relative threshold time described above), open the code segment 103. For example, an absolute threshold criteria may be “in response to an execution time of a code segment 103 exceeding 250 milliseconds for all the executions of the code segment 103 that occurred in the last minute, open the code segment 103”. As with the relative/absolute threshold times, a threshold criteria may be a hybrid and/or conditional: when there are enough historical time indicators, use a relative threshold criteria, otherwise use an absolute threshold criteria.

Furthermore, each code segment 103 and/or connection of a circuit may be associated with a different threshold. For example a first code segment 103 of a circuit may have a lower threshold time than a second code segment 103 of the circuit.

One or both of the engines 109, 110 may determine (e.g., when dynamic) and/or store the thresholds.

When a code segment 103, and the like, is determined to be open, the CB awareness engine 110 may modify the request, prior to providing the request to the application module 101, to include CB indications which identify an open code segment 103 and/or open code segments 103 and/or an open circuit. For example, a CB indication may include a line number of an execution location marker 105 at the beginning of an open connection and/or which precedes an open code segment 103. The CB indication may be in the header of the request. The execution location marker 105 at the line number received in the header of the request may: return an exception (such as an error, and the like) for the open code segments 103 associated with the execution location marker 105 at the line number received in the header of the request. Such an exception may cause the application engine 101 to not implement the open code segment 103 following the execution location marker 105 which returned the exception, which may cause the application engine 101, and/or a distributed system, of which the system 100 may be a component, to run more efficiently as the application engine 101 does not wait for a slow 103 (and now open) code segment to execute.

Hence, the execution location markers 105 may be further to: return the exception for the open code segments 103 based on the request, as modified to include the CB indications.

The CB awareness engine 110 may determine whether code segments 103, and the like, are open or closed (or half-open, as described below) when requests to implement the application engine 101 are received. Similarly, the CB awareness builder engine 109 may continue to receive and store time indicators when responses to the requests are generated by the application engine 101. As such, the system 100 continues to collect time indicators for code segments 103, and the like, on an on-going basis, which are used to determine whether code segments 103, and the like, are open or closed on an on-going basis. Hence, the system 100 dynamically breaks circuits and/or closes circuits on an on-going basis, without being in a test mode.

Once a code segment 103 is determined to be opened, time indicators for the code segment 103 may not be received with responses due to the associated exceptions which are generated. As such, the CB awareness engine 110 may be further to: determine (e.g., in response to receiving a request and/or independent of a request) that an open code segment 103, as determined from the time indicators, is “half-open” after a given time period has passed; and, in response, cause a request to indicate that the open code segment 103 is closed.

Put another way, once a code segment 103, and the like, is determined to be open, the CB awareness engine 110 may store data indicating that the code segment 103 is open; subsequent requests may be modified based on the data and/or by again communicating with the CB awareness builder engine 109 to determine that a code segment 103, and the like is open.

The CB awareness engine 110 may be further to determine a length of time that has passed since a code segment 103 was determined to be open (e.g., independent of receiving any requests), and compare the length of time against a pre-determined given time period, for example, a few seconds, and/or any other suitable time period. When the length of time is greater than the given time period, the CB awareness engine 110 may update the data to indicate that the code segment 103 is “half-open” and the request may indicate that the “half-open” code segment 103 is closed such that the application engine 103 processes the “half-open” code segment 103 as a closed segment 103; the request indicating that the “half-open” code segment 103 is closed may be an absence of a CB indicator for the “half-open” code segment 103. The state of a code segment 103 being “half-open” is generally “known” to the CB awareness engine 110, even as the application engine 101 treats the half-open code segment 103 as a closed code segment 103 (e.g., to test an execution time of the half-open code segment 103).

As such, a code segment 103 being designated as a half-open code segment 103 causes the code segment 103 to again be implemented and time indicators identifying times to execute the half-open code segment 103 are again received at, and stored by, the CB awareness builder engine 109.

When yet another subsequent request is received at the CB awareness engine 110, the CB awareness engine 110 may determine, from the time indicators, that a half-open code segment 103 has successfully executed within a respective threshold time. Hence, the CB awareness engine 110 may change the half-open code segment 103 to a closed code segment 103, and the subsequent request provided to the application engine 101 again indicates that the code segment 103 is closed, accordingly. In some examples, changing a half-open code segment 103 to a closed code segment 103 includes the CB awareness engine 110 no longer storing data for the code segment 103 indicating that the code segment 103 is open or half-open; put another way, the CB awareness engine 110 may only store data for code segments 103 ha are open or half-open.

However, in examples where a half-open code segment 103 does not successfully execute within a respective threshold time, as determined from time indicators, the CB awareness engine 110 may: change the half-open code segment 103 back to an open code segment 103; and, thereafter, change the open code segment 103 back to a half-open code segment 103 after another given time period. Indeed, a “back-off” of the code segment 103 from and an open code segment to a closed code segment, may occur in staged manner to periodically test the execution time of the code segment 103 until the code segment 103 is closed, Such a “back-off” may occur exponentially.

For example, the CB awareness engine 110 may change the open code segment 103 to a half-open code segment 103 after a first given time period. in response to the half-open code segment 103 successfully executing within a respective threshold time, the CB awareness engine 110 may: change the half-open code segment 103 to a closed code segment 103, In response to the half-open code segment 103 not successfully executing within the respective threshold time, the CB awareness engine 110 may: change the half-open code segment 103 back to the open code segment 103; and, thereafter, change the open code segment 103 back to the half-open code segment 103 after a second given time period greater than the first given time period. Such a process may be exponential (e.g., exponential back-off) such that the second given time period being greater than the first given time period may be selected in an exponential manner.

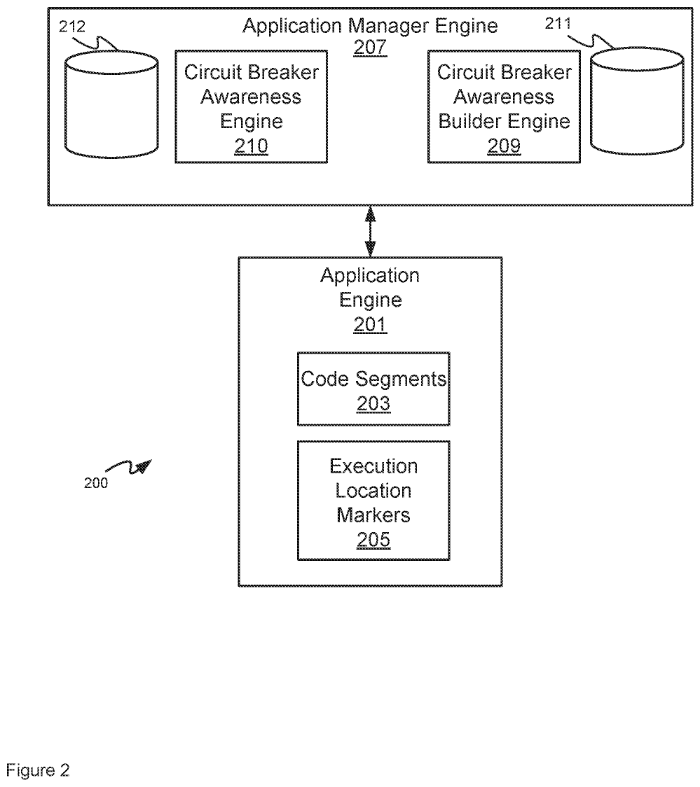

Attention is next directed to FIG. 2 which is a block diagram of another example system 200 to implement self-adaptive circuit breakers for applications that include execution location markers. The system 200 is substantially similar to the system 100, with like components having like numbers, but in a “200” series rather than a “100” series. For example, the system 200 may include an application engine 201 comprising code segments 203 and execution location markers 205, and an application manager engine 207 that includes a CB awareness builder engine 209 and a CB awareness engine 110; the application engine 201, the code segments 203, the execution location markers 205, the CB awareness builder engine 209, and the CB awareness engine 210 are respectively similar to the application engine 101 the code segments 103, the execution location markers 105, the CB awareness builder engine 109, and the CB awareness engine 110 as described above.

However, in contrast to the system 100, in the system 200 includes the application manager engine 207 (which includes the CB awareness builder engine 209 and the CB awareness engine 210), a memory 211 and a memory 212.

In general, the CB awareness builder engine 209, the CB awareness engine 210 and the memories 211, 212 may be components of the application manager engine 207, such as an API of the application engine 201. In some examples, the memory 211 may be a component of the CB awareness builder engine 209, and the memory 212 may be a component of the CB awareness engine 210. In yet other examples, the memories 211, 212 may be a shared memory, shared by the engines 209, 210.

The memories 211, 212 may include databases and the like, which are local to the application manager engine 207. The memory 211 may store the time indicators received with a response from the application engine 201. In particular, the memory 211 may store the time indicators according to a domain specific language (DSL) format and/or in any other suitable format. The memory 212 may store data indicating whether a code segment 203 is open or half-open in any suitable format, which may also be a DSL format.

The CB awareness engine 210 and the CB awareness builder engine 209 may further be to communicate with each other to determine whether a code segment is open or closed (or half-open) based on the time indicators. For example, the memory 211 may be accessible via the CB awareness builder engine 209, for example within the application manager engine 207. When the CB awareness engine 210 receives a request to process the application engine 201, the CB awareness engine 210 may communicate with the CB awareness builder engine 209 to retrieve the time indicators from the memory 211. When the CB awareness engine 210 determines that a code segment 203 is open or half-open, the CB awareness engine 210 may store data indicating that the code segment 203 is open or half-open at the memory 212. When the CB awareness engine 210 determines that a code segment 203 which was previously open or half-open is now closed, the CB awareness engine 210 may remove the data indicating that the code segment 203 is open or half-open from the memory 212.

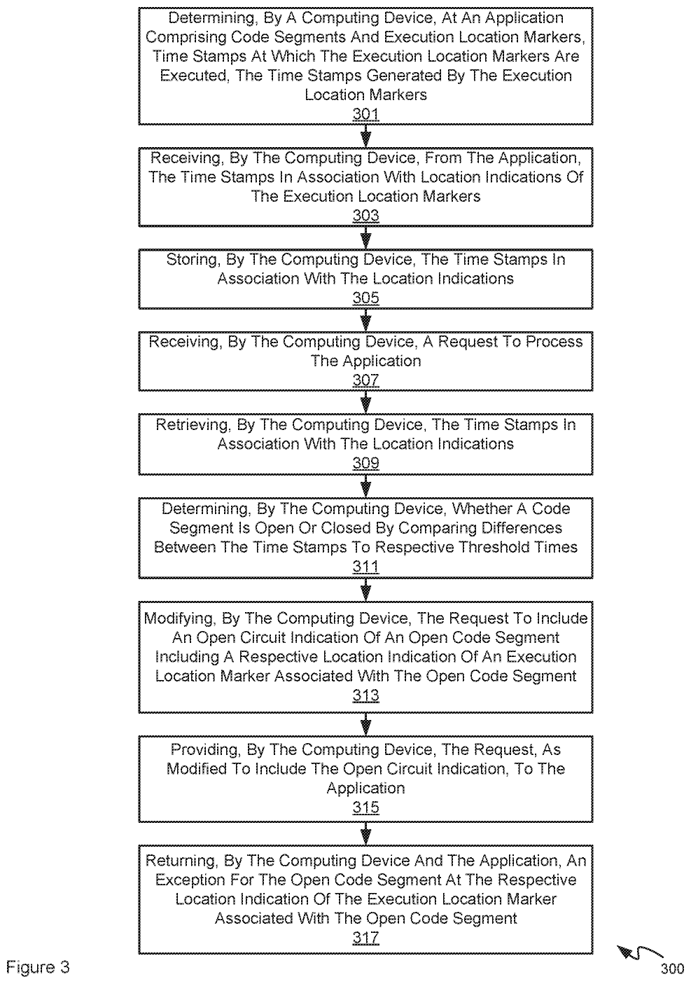

Referring to FIG. 3, a flowchart of an example method 300 to implement a method to implement self-adaptive circuit breakers for applications that include execution location markers is depicted. In order to assist in the explanation of method 300, it will be assumed that method 300 may be performed with the system 200, and at least partially by a computing device implementing the system 200 and/or a processor thereof. Indeed, the method 300 may be one way in which the system 200 may be configured. Furthermore, the following discussion of method 300 may lead to a further understanding of the system 200, and its various components. Furthermore, it is to be emphasized, that method 300 may not be performed in the exact sequence as shown, and various blocks may be performed in parallel rather than in sequence, or in a different sequence altogether. Furthermore, it is to be emphasized that the method 300 may alternatively be performed with the system 100, and at least partially by a computing device implementing the system 100 and/or a processor thereof

Beginning at a block 301, a computing device determines, at an application comprising code segments and execution location markers, time stamps at which the execution location markers are executed, the time stamps generated by the execution location markers. In particular, the application may be implemented by the application engine 201 and the code segments and execution location markers may be implemented, respectively, as the code segments 203 and the execution location markers 205.

At a block 303, the computing device receives, from the application, the time stamps in association with location indications of the execution location markers 205. The time stamps and the location indications may be received at the CB awareness builder engine 209, as described above. The time stamps may be received as the time indicators described above. The location indications may be received as the time indicators described above and/or the location indications may be received with the time stamps. The time stamps and the location indications may be received with a response provided by the application, generated in response to a previous request to process the application (for example from a requesting device and/or a client device).

At a block 305, the computing device stores the time stamps in association with the location indications, for example at the memory 211 using the CB awareness builder engine 209.

At a block 307, the computing device receives a request to process the application, for example from a requesting device and/or a client device. The request may be received at the CB awareness engine 210.

At a block 309, the computing device retrieves the time stamps in association with the location indications. For example, the CB awareness engine 210 may retrieve the time stamps and the location indications from the memory 211 via the CB awareness builder engine 209.

At a block 311, the computing device determines whether a code segment 203, and the like, is open or closed by comparing differences between the time stamps to respective threshold times. Such a comparison may occur at the CB awareness engine 210. As described above, the respective threshold times may be based on statistics for execution times for respective code segments 203, defined by pairs of execution location markers 205 associated with the respective code segment 203.

The computing device may compare differences in time stamps for location indictors that are closest together. Hence, for example, when time stamps for execution location markers 205 at lines 3, 5 and 7 of the application are received, the difference between time stamps for lines 3 and 5 is determined (e.g., which indicate an execution time for a code segment 103 and/or connection between lines 3 and 5), and the difference between time stamps for lines 5 and 7 is determined (e.g., which indicate an execution time for a code segment 103 and/or connection between lines 5 and 7). When the difference between time stamps for lines 3 and 5 is determined to be greater than a threshold, the code segment 103 and/or connection between lines 3 and 5 is determined to be open; similarly, when the difference between time stamps for lines 5 and 7 is determined to be greater than a threshold (which may be the same or different than the threshold used for lines 3 and 5), the code segment 103 and/or connection between lines 5 and 7 is determined to be open.

At a block 313, the computing device modifies the request to include an open circuit indication of an open code segment 203 including a respective location indication of an execution location marker 205 associated with the open code segment 203. In some examples, modifying the request to include the open circuit indication comprises modifying adding a header to the request that includes the open circuit indication. For example, the request may comprise an HTTP request and a header of the HTTP request may be modified to include the open circuit indication. In particular, when the code segment 103 and/or connection between lines 3 and 5 of the application is determined to be open, the open circuit indication may comprise an indicator of line 3; similarly, when the code segment 103 and/or connection between lines 5 and 7 of the application is determined to be open, the open circuit indication may comprise an indicator of line 5.

At a block 315, the computing device provides the request, as modified to include the open circuit indication, to the application (e.g., to the application engine 201).

At a block 317, the computing device returns an exception for the open code segment 203 at the respective location indication of the execution location marker 205 associated with the open code segment 203. As such, the open code segment 203 does not execute. For example, when an open code segment 103 is between lines 3 and 5 of the application, the execution location marker 205 at line 3 (as indicated by the open circuit indication) may return an exception (e.g., an error), causing the code segments 203 following line 3 not to execute. The computing device returns an exception for the open code segment 203 may include a response of the application indicating an error, and the like.

In some examples, the CB awareness engine 210 may change the open code segment 203 to a half-open code segment 203, for example to test the code segment 203. In some of these examples, the method 300 may include the computing device: changing the open code segment 203 to a half-open code segment 203 after a first given time period; in response to the half-open code segment 203 successfully executing within a respective threshold time: changing the half-open code segment 203 to a closed code segment 203; and/or in response to the half-open code segment 203 not successfully executing within the respective threshold time: changing the half-open code segment 203 back to the open code segment 203; and, thereafter, changing the open code segment 203 back to the half-open code segment 203 after a second given time period greater than the first given time period. For example, the computing device may use exponential back-off to change the open code segment 203 to a closed code segment 203.

However, an open code segment 203 may be changed to a half-open code segment 203 or a closed code segment 203 in any suitable manner. In some examples, the method 300 may include the computing device: receiving a second request to process the application (e.g., after the request received at the block 301); in response to the second request being received after a given time period from receipt of the request, changing an open code segment 203 to a half-open code segment 203; causing the second request to indicate that the half-open code segment 203 is closed (e.g., the second request may indicate that the code segment 203 is closed via an absence of a line number of the execution location marker 205 which precedes the code segment 203); providing the second request to the application; processing, by the computing device and the application, the half-open code segment 203 to determine respective time stamps at which respective execution location markers were executed for the half-open code segment 203; and updating stored time stamps with the respective time stamps to determine whether the half-open code segment 203 is to be changed to a closed code segment 203 or back to the open code segment 203.

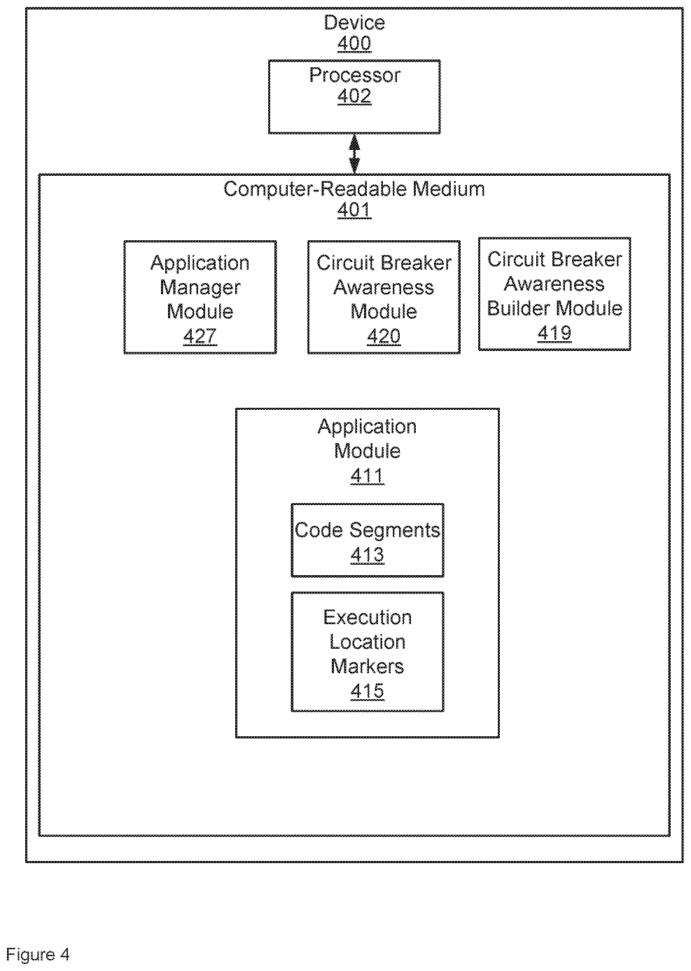

FIG. 4 is a block diagram of an example device 400 that includes a computer-readable medium 401 and a processor 402. The computer-readable medium 401 includes instructions that, when implemented by the processor 402, cause the processor 402 to implement self-adaptive circuit breakers for applications that include execution location markers.

The computer-readable medium 401 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like.

The processor 402 may be a general-purpose processor or special purpose logic, such as a microprocessor (e.g., a central processing unit, a graphics processing unit, etc.), a digital signal processor, a microcontroller, an ASIC, an FPGA, a programmable array logic (PAL), a programmable logic array (PLA), a programmable logic device (PLD), etc. The computer-readable medium 401 or the processor 402 may be distributed among a plurality of computer-readable media or a plurality of processors.

The computer-readable medium 401 includes modules. As used herein, a “module” (in some examples referred to as a “software module”) is a set of instructions that when implemented or interpreted by a processor or stored at a processor-readable medium realizes a component or performs a method.

The computer-readable medium 401 may include an application module 411 comprising code segments 413 and execution location markers 415 to: determine time indicators identifying times to execute the code segments 413; and return an exception for open code segments 413 at locations indicated by respective location indications of respective execution location markers 415 received in a request.

Similar to execution location markers as described above, the application module 411 comprises the execution location markers 415 at a plurality of locations associated with a code segment 413, and the time indicators for the code segment 413 may indicate execution times between pairs of the execution location markers 415 associated with the code segment 413.

The computer-readable medium 401 may include a CB awareness builder module 419. The CB awareness builder module 419 may include instructions that, when implemented, cause the processor 402 to: receive from the application module 411, the time indicators identifying the times to execute the code segments 413 in association with location indications of the execution location markers 415; and store the time indicators with the location indications.

The computer-readable medium 401 may include a CB awareness module 420. The CB awareness module 420 may include instructions that, when implemented, cause the processor 402 to: receive the request to process the application module 411; retrieve, via the CB awareness builder module 419, the time indicators and the location indications for the code segments 413; determine whether a code segment 413 is open or closed based on the time indicators; modify the request with CB indications of respective code segments 413 of the application module 101 being open including the respective location indications of the respective execution location markers 415; and provide the request, as modified, to the application module 411 to cause the application module 411 to return the exception for the open code segments 413 at locations indicated by the respective location indications of the respective execution location markers 415. Similar to as described above, the CB awareness module 420 may be further to determine whether a code segment 2-4 is open or closed based on statistics for execution times for respective code segments 413, defined by pairs of execution location markers 415 associated with the respective code segments 413.

In some examples, the instructions of the CB awareness module 420, when executed, may further cause the processor 402 to: use exponential back-off to change the open code segment 413 to a closed code segment 413, for example by changing the open code segment 413 to a half-open code segment 413 to test an execution time of the half-open code segment 413.

The computer-readable medium 401 may include an application manager module 427, The application manager module 427 may include instructions that, when implemented, cause the processor 402 to receive the request and pass the request to the CB awareness module 420. The application manager module 427 may comprise an application programming interface (API) comprising the CB awareness builder module 419 and the CB awareness module 420. Regardless, the application manager module 427 comprising the CB awareness builder module 419 and the CB awareness module 420, whether in an API or another suitable format.

An example of code segments 203, circuits, connections, and execution locations markers 205 are next described with respect to FIG. 5. In particular, FIG. 5 depicts a code snippet 500 in Java-like code, called “WebApp”. Various functions, and other parts of the code snippet 500, are on various lines indicated by line numbering 501. The code snippet 500 may be an example of code segments 203 and execution locations markers 205 of the application engine 101, the application engine 201 and/or the application module 411. While execution locations markers 205 are depicted in specific locations in the code snippet 500, the execution locations markers 205 may be located in any suitable location, and may be added manually and/or automatically.

The code snippet 500 generally implements a function “dataValidation(input)′” using an integer “input” (e.g., to perform a data validation), and implements a function “businessLogic(input)”. The integer “input” may be received in a request to process the code snippet 500 (e.g., a request to process the application engine 101, the application engine 201 and/or the application module 411). Each of the functions may be code segments 203.

As depicted, the code snippet 500 further comprises execution location markers 205, for example a function “passedHere( )” which may call a function which may return time indicators identifying times to execute the code segments such as a time stamp and a line number thereof, A code segment 203 may be between given pairs of the function “passedHere( )” (and/or pairs of execution location markers 205), and the time indicators returned may indicate further behavior of the code segment 203 therebetween, such as an execution time of a respective code segment 203.

Regardless, the time indicators returned by the function “passedHere( )” are stored by the CB awareness builder engine 209 and used by the CB awareness builder module 419 to determine when a code segment 203 is open or closed.

As depicted, the code snippet 500 further includes annotations identified using “II”. For example, line numbers 3, 5, and 7, which include execution location markers 205, are each annotated as a “behavior” step which determine a time stamp, and the like using the passedHere( )function. The line numbers 3, 5, and 7 are also annotated to indicate a line number of the “WebApp” on which an execution location marker 205 is located. For example, line number 3 is annotated as “[WebApp:03]”. Hereafter, the annotation [WebApp:#] will refer to a line number and/or a step of the “WebApp”.

The code snippet 500 further includes two connections: a first connection from line number 3 to line number 5, indicated by the annotation at line number 4 as “connection [WebApp:03] to[WebApp:05]”; and a second connection from line number 5 to line number 7, indicated by the annotation at line number 4 as “connection [WebApp:05]to[WebApp:07]”.

The code snippet 500 hence includes one circuit from [WebApp:03] to [WebApp:07] (e.g., line 3 to line 7) that comprises two connections: [WebApp:03]to[WebApp:05] and [WebApp:05]to[WebApp:07].

The connection [WebApp:03]to[WebApp:05], when open, will not allow the execution of the functions dataValidation( )and businessLogic( ) because an exception will occur when the step [WebApp:03] is executed; for example, a request to implement “WebApp” will include the line number 3, which causes the function passedHere( )on line 3 to return an exception and/or an error. Connection [WebApp:05]to[WebApp:07], when open, will not

Similarly, the connection [WebApp:05]to[WebApp:07], when open, will not allow the execution of the function businessLogic( ), because an exception will occur when the step [WebApp:05] is executed; for example, a request to implement “WebApp” will include the line number 5, which causes the function passedHere( )on line 5 to return an exception and/or an error.

The circuit [WebApp:03] to [WebApp:07] may be determined to be open when either of the connections [WebApp:03]to[WebApp:05], [WebApp:03] to [WebApp:07] are open.

Various examples of circuit breaking in the WebApp are now described assuming that code snippet 500 is part of the application engine 201, and the CB awareness engine 210 is to: open a connection and/or a code segment 203 when a performance thereof degrades (e.g., an execution time exceeds more than one standard deviation from a mean in a Gaussian distribution of a last 100 successful executions); places a connection and/or a code segment 203 in a half-opened state according to an exponential back-off, starting from one second from when the connection and/or the code segment 203 was opened; and close a half-opened a connection and/or a code segment 203 when an execution time is less than one standard deviation from a mean in a Gaussian distribution of a last 100 successful executions.

In a particular example, the following thresholds may be used for the connections [WebApp:03]to[WebApp:05] and [WebApp:05]to[WebApp:07]:

[WebApp:03]to[WebApp:05]: threshold time of 120 milliseconds, for example presuming an average execution time of 90 milliseconds, and a standard deviation of 30 milliseconds;

[WebApp:05]to[WebApp:07]: threshold time of 250 milliseconds, for example presuming an average execution time of 150 milliseconds, and a standard deviation of 100 milliseconds.

The following examples of HTTP request handling indicates how the WebApp's connections and/or code segments 203 may be changed between open, closed and half-open states:

1. An HTTP request Request1 is received at WebApp at an Instant1. In this example, Request 1 requires a total of 400 milliseconds to be processed by the WebApp, of which 100 milliseconds are spent in connection [WebApp:03]to[WebApp:05] and 300 milliseconds are spent in connection [WebApp:05]to[WebApp:07]. While the performance of connection [WebApp:03]to[WebApp:05] may be determined to be within an acceptable limits (e.g.; the execution time of 100 milliseconds is less than or equal 120 milliseconds) and the connection[WebApp:03]to[WebApp:05], and/or the codes segment 203 on line 4 remains closed. However, the performance of connection [WebApp:05]to[WebApp:07] may be determined to be unacceptable (e.g.; the execution time of 300 milliseconds is greater than 250 milliseconds); hence, the CB awareness engine 210 opens the connection[WebApp:05]to[WebApp:07], and/or the codes segment 203 on line 6. As described above; the determination of the execution times of the connection [WebApp:03]to[WebApp:05] is determined from time stamps for the execution location markers 205 on lines 3 and 5, as previously stored at the memory 211; the determination of the execution times of the connection [WebApp:05]to[WebApp:07] is determined from time stamps for the execution location markers 205 on lines 5 and 7, as previously stored at the memory 211

2. An HTTP request Request2 (and/or a plurality of requests) is received at the CB awareness engine 210 between the Instant 1 and one second from Instant 1 (e.g., at which time the open connection [WebApp:05]to[WebApp:07] is changed to a half-open connection). When the request is received at the CB awareness engine 210, the connection [WebApp:03]to[WebApp:05] is closed and the connection [WebApp:05]to[WebApp:07] is open. Hence, the CB awareness engine 210 adds a header to the Request2 (and/or modifies a header of the Request2) indicating that the connection[WebApp:05]to[WebApp:07] is open; such as a line number “5”, and the Request 2, as modified; is provided to the WebApp. The WebApp implements normally by the RESTful application up to line 5 (e.g., a start of the connection[WebApp:05]to[WebApp:07]) where the execution location marker 205 at the the behavior step [WebApp:05] is executed and an aborting exception is thrown.

3. An HTTP request Request3 (which follows Request2) is received at the CB awareness engine 210 after Instant 1 plus one second. Hence, when Request3 is received, the connection [WebApp:03]to[WebApp:05] is closed and the connection [WebApp:05]to[WebApp:07] is half-opened. Hence, both of the connections [WebApp:03]to[WebApp:05], [WebApp:05]to[WebApp:07] are implemented at the WebApp and/or handled as closed connections (e.g., executed normally). The half-open state of the connection [WebApp:05]to[WebApp:07] is stored may be stored at the memory 212. However, when the execution time of the connection [WebApp:05]to[WebApp:07] remains greater than 250 milliseconds, the CB awareness engine 210 again opens the connection [WebApp:05]to[WebApp:07], this time for more 2 seconds, according to a configured exponential back-off. However, when the execution time of the connection [WebApp:05]to[WebApp:07] is less than or equal to 250 milliseconds, the CB awareness engine 210 closes the connection [WebApp:05]to[WebApp:07].

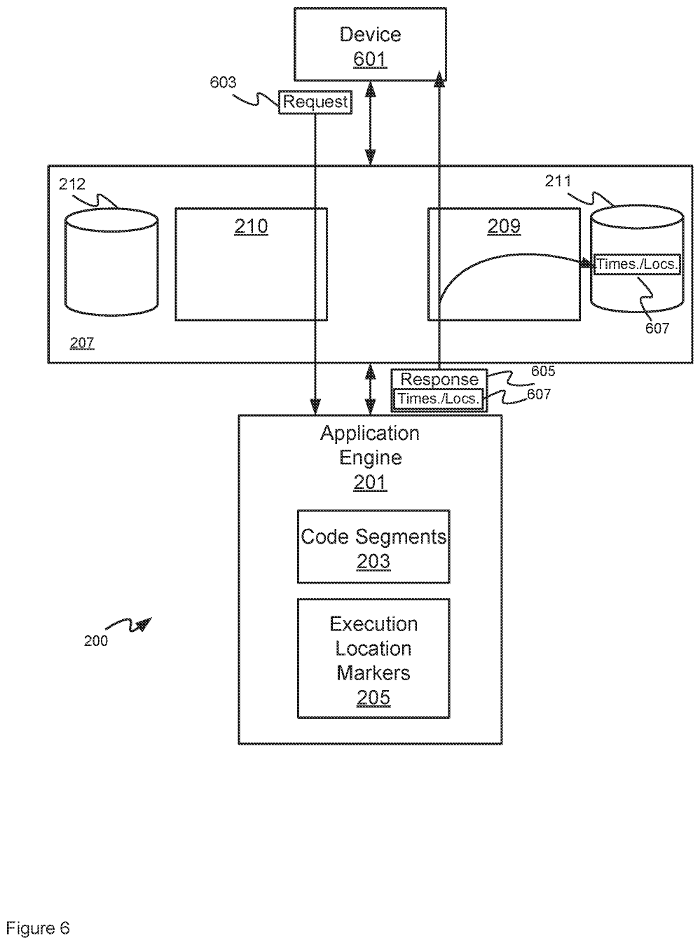

Attention is next directed to FIG. 6 which depicts the system 200 implementing the method 300. In FIG. 6, it is understood that initially no time stamps and/or time indications and/or location indicators are stored at the memory 211.

In FIG. 6, the system 200 is depicted with a device 601 in communication with the application engine 201 via the application manager engine 207, for example using a communication network and the like. The device 601 transmits a request 603 to the application engine 201 via the application manager engine 207, the request 603 to implement the application engine 201. For example, the request 603 may be generated at a browser application at the device 601, and the request 603 may be for a website implemented via the application engine 201.

The request 603 is received (e.g., at the block 301 of the method 300) at the application engine 201 via the CB awareness engine 210, and as no time stamps (and/or time indicators) are stored at the memory 211, the request 603 is not modified.

The application engine 201 returns a response 605 (e.g., at the block 303 of the method 300) which includes timestamps and location indicators 607 generated by the execution location markers 205, as described above. The response 605 is received at the CB awareness builder engine 209, which stores (e.g., at the block 305 of the method 300) the timestamps and location indicators 607 at the memory 211. The response 605 is transmitted to the device 601 (e.g., with, or without, the timestamps and location indicators 607).

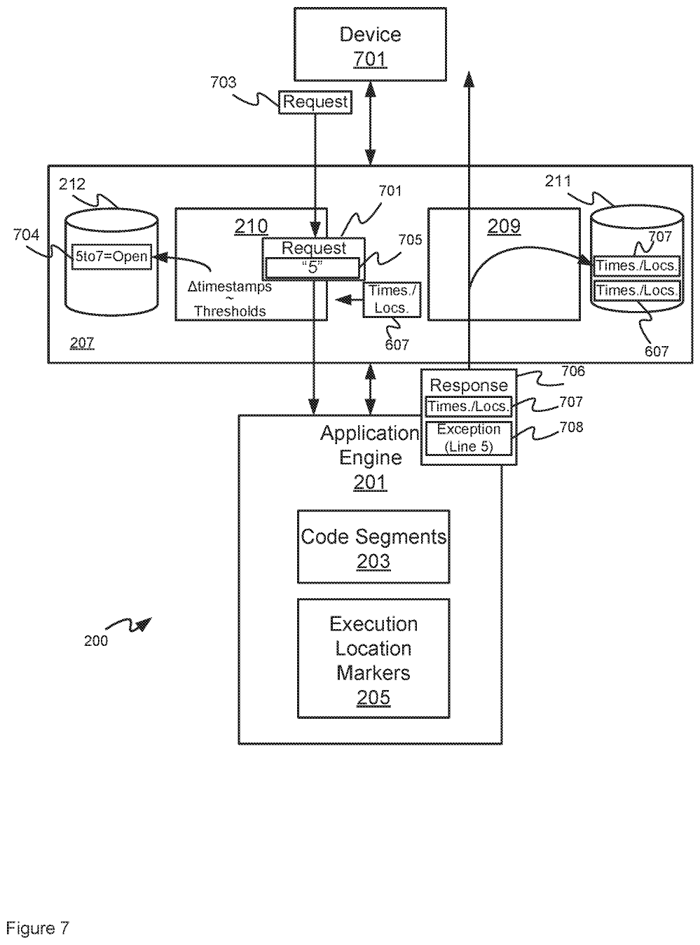

Attention is next directed to FIG. 7 which depicts the system 200 with the timestamps and location indicators 607 stored at the memory 211, and with another device 701 (which may be the same or different from the device 601) in communication with the application engine 201 via the application manager engine 207. The device 701 transmits a request 703 to the application engine 201 via the application manager engine 207, the request 703 to implement the application engine 201. The request 703 may be the similar to, or different from, the request 603.

The request 703 is received (e.g., at the block 307 of the method 300) at the CB awareness engine 210, and the timestamps and location indicators 607 are retrieved (e.g., at the block 309 of the method 300).

The CB awareness engine 210 determines (e.g., at the block 311 of the method 300) whether a code segment 203 (and/or circuit and/or a connection) is open or closed by comparing the differences in the time stamps to threshold times. As depicted, the CB awareness engine 210 has determined that a connection (e.g., a code segment 203 thereof) between lines 5 and 7 of the application engine 201 is open and stores data 704 at the memory 212 indicating that the connection between lines 5 and 7 is open.

The CB awareness engine 210 modifies (e.g., at the block 313 of the method 300) the request 703 to include an open circuit indication 705 of an open code segment 203 and/or an open connection, for example, as depicted, a line number “5” indicating a line number of the application engine 201 at which a first execution location marker 205 that precedes the open code segment 203 is located and/or a first line number of the open connection.

The request 703, as modified, is provided (e.g., at the block 315 of the method 300) by the CB awareness engine 210 to the application engine 201.

The application engine 201 receives the request 703, as modified and returns (e.g., at the block 315 of the method 300) a response 706 which includes timestamps and location indicators 707 generated by the execution location markers 205 that are executed in response to receiving the request 703, as modified, as well as an exception 708 (e.g., generated by the execution location marker 205 at line number 5). The exception 708 is generated when the line number 5 is reached, based on the open circuit indication 705 indicating the line number 5.

The response 706 is received at the CB awareness builder engine 209, which stores the timestamps and location indicators 707 at the memory 211. The response 706 is transmitted to the device 601 (e.g., with, or without, the timestamps and location indicators 707, but with the exception 708). The device 701 receives the response 706 with the exception 708 and may determines that an exception (and/or an error) has occurred at the application engine 201.

When further requests are received, determining whether code segments 203 and/or connections are open or closed may be based on the timestamps and location indicators 607, 707. Furthermore, open code segments 203 and/or connections may be changed to half-open code segments 203 and/or connections after a given time period (e.g., independent of a request being received).

In any event, provided herein are devices, system and methods for implementing self-adaptive circuit breakers for applications that include execution location markers.

It should be recognized that features and aspects of the various examples provided above may be combined into further examples that also fall within the scope of the present disclosure.

1. A system comprising:
an application engine comprising code segments and execution location markers which return time indicators identifying times to execute the code segments;
a circuit breaker (CB) awareness builder engine to: receive from the application engine, the time indicators; and store the time indicators;
a CB awareness engine to: receive a request to process the application engine; retrieve, via the CB awareness builder engine, the time indicators; determine whether a code segment is open or closed based on the time indicators; modify the request to include CB indications of respective code segments of the application engine that are open; and provide the request, as modified to include the CB indications, to the application engine to cause the application engine to return an exception for open code segments in response to receiving the request, as modified to include the CB indications.

2. The system of claim 1, wherein the execution location markers are further to: return the exception for the open code segments based on the request, as modified to include the CB indications.

3. The system of claim 1, wherein the CB awareness engine is further to: compare the times to a threshold to determine whether the code segment is open or closed.

4. The system of claim 1, wherein the CB awareness engine is further to: determine that an open code segment, as determined from the time indicators; is half-open after a given time period has passed; and, in response, cause a subsequent request to indicate that the open code segment is closed.

5. The system of claim 1, wherein the time indicators indicate execution delay times for the respective code segments.

6. A method comprising:
determining, by a computing device, at an application comprising code segments and execution location markers, time stamps at which the execution location markers are executed, the time stamps generated by the execution location markers;
receiving, by the computing device, from the application, the time stamps in association with location indications of the execution location markers;
storing, by the computing device, the time stamps in association with the location indications;
receiving, by the computing device, a request to process the application;
retrieving, by the computing device, the time stamps in association with the location indications;
determining, by the computing device, whether a code segment is open or closed by comparing differences between the time stamps to respective threshold times;
modifying, by the computing device, the request to include an open circuit indication of an open code segment including a respective location indication of an execution location marker associated with the open code segment;
providing, by the computing device, the request, as modified to include the open circuit indication, to the application; and
returning, by the computing device and the application, an exception for the open code segment at the respective location indication of the execution location marker associated with the open code segment.

7. The method of claim 6, wherein the respective threshold times are based on statistics for execution times for respective code segments.

8. The method of claim 6, wherein the modifying the request to include the open circuit indication comprises adding a header to the request that includes the open circuit indication.

9. The method of claim 6, further comprising:
changing, by the computing device, the open code segment to a half-open code segment after a first given time period;
in response to the half-open code segment successfully executing within a respective threshold time: changing, by the computing device, the half-open code segment to a closed code segment;
in response to the half-open code segment not successfully executing within the respective threshold time: changing, by the computing device, the half-open code segment back to the open code segment; and, thereafter, changing, by the computing device, the open code segment back to the half-open code segment after a second given time period greater than the first given time period.

10. The method of claim 6, further comprising:
receiving, by the computing device, a second request to process the application;
in response to the second request being received after a given time period from receipt of the request, changing, by the computing device, the open code segment to a half-open code segment;
causing the second request to indicate that the half-open code segment is closed;
providing, by the computing device, the second request to the application;
processing, by the computing device and the application, the half-open code segment to determine respective time stamps at which respective execution location markers were executed for the half-open code segment; and
updating, by the computing device, stored time stamps with the respective time stamps to determine whether the half-open code segment is to be changed to a closed code segment or back to the open code segment.

11. A non-transitory computer-readable medium comprising instructions that, when executed by a processor, cause the processor to:
execute an application module comprising code segments and execution location markers to: determine time indicators identifying times to execute the code segments; and return an exception for open code segments at locations indicated by respective location indications of respective execution location markers received in a request;
execute a circuit breaker (CB) awareness builder module to: receive from the application module, the time indicators identifying the times to execute the code segments in association with location indications of the execution location markers; and store the time indicators with the location indications;
execute a CB awareness module to: receive the request to process the application module; retrieve, via the CB awareness builder module, the time indicators and the location indications for the code segments; determine whether a code segment is open or closed based on the time indicators; modify the request with CB indications of respective code segments of the application module being open including the respective location indications of the respective execution location markers; and provide the request; as modified, to the application module to cause the application module to return the exception for the open code segments at locations indicated by the respective location indications of the respective execution location markers.

12. The non-transitory computer-readable medium of claim 11, further comprising an application manager module comprising the CB awareness builder module and the CB awareness module.

13. The non-transitory computer-readable medium of claim 11, wherein the CB awareness module is further to determine whether the code segment is open or closed based on the time indicators based on statistics for execution times for the respective code segments, defined by pairs of execution location markers associated with the respective code segments.

14. The non-transitory computer-readable medium of claim 11, wherein the application module comprises the execution location markers at a plurality of locations associated with a code segment, the time indicators for the code segment indicating execution times between pairs of the execution location markers associated with the code segment.

15. The non-transitory computer-readable medium of claim 11, wherein the instructions, when executed, further cause the processor to: use exponential back-off to change the open code segment to a closed code segment.
